(19) United States
(12) Patent Application Publication
(10) Pub. No.: US 2026/0024876 A1
(43) Pub. Date: Jan. 22, 2026

(54) HYBRID MEMBRANE, PREPARATION METHODS AND APPLICATIONS THEREOF, AND ELECTROCHEMICAL DEVICE COMPRISING THE SAME

(71) Applicant: NANO AND ADVANCED MATERIALS INSTITUTE LIMITED, HONG KONG (CN)

(72) Inventors: Yan Lung WONG, HONG KONG (CN); Jishi YANG, HONG KONG (CN); Shengbo LU, HONG KONG (CN); Chenmin LIU, HONG KONG (CN)

(73) Assignee: NANO AND ADVANCED MATERIALS INSTITUTE LIMITED, HONG KONG (CN)

(21) Appl. No.: 19/080,932

(22) Filed: Mar. 17, 2025

Related U.S. Application Data
(60) Provisional application No. 63/672,714, filed on Jul. 18, 2024.

(51) Int. Cl. H01M 50/417; H01M 4/02; H01M 4/38; H01M 4/583; H01M 50/449

(52) U.S. Cl. CPC H01M 50/417; H01M 4/382; H01M 4/583; H01M 50/449; H01M 2004/027; H01M 2004/028

(57) ABSTRACT

The present disclosure relates to a hybrid membrane used for an electrochemical device, and the hybrid membrane comprises: a membranous layer comprising a modified metal-organic framework (MOF) material, wherein the modified MOF material is a MOF material modified with one or more of lithium salts, carboxylic acids, or amino acids, and a binder material, for adhering the modified MOF materials onto a porous support layer to form the membranous layer thereon; and a porous support layer, for providing mechanical support for the membranous layer. The present disclosure also relates to a method for preparing the hybrid membrane, an electrochemical device comprising the hybrid membrane, and use of the hybrid membrane for suppressing Lewis acidic byproducts in an electrochemical device.

### CROSS-REFERENCE TO RELATED APPLICATION

This application claims the priority benefits of U.S. provisional application Ser. No. 63/672,714, filed on Jul. 18, 2024. The entirety of the above-mentioned patent applications is hereby incorporated by reference herein and made a part of this specification.

### TECHNICAL FIELD

The present disclosure belongs to the field of electrochemistry. Particularly, the present disclosure relates to a hybrid membrane used for an electrochemical device, a method for preparing the hybrid membrane, an electrochemical device comprising the same, and applications thereof.

### BACKGROUND

Lithium metal featuring a high theoretical capacity (3860 mAh·g⁻¹), a low reduction potential (−3.04 V versus the standard hydrogen electrode), and a low density (0.534 g·cm⁻³) is considered as a promising anode to significantly advance the energy density of lithium-based batteries.^{1,2} However, in the prior art, lithium metal batteries (LMBs) constructed by lithium metal anodes suffer from poor cycling stability and short life span. The major cell failure mechanisms for LMBs include: 1) uneven current density and random nucleation sites leading to fast growth of dendritic lithium; 2) severe side reactions between unstable non-aqueous electrolytes and reactive metallic lithium; 3) poor ionic conductivity of polyolefin-based separators limiting the rate capability of LMBs. In addition, the byproducts such as HF, CO₂, PF₅ and H₂, generated in the process of charging and discharging of lithium-based batteries, may cause battery expansion, which would pose a serious threat to human safety.

Various strategies have been tried to mitigate or, hopefully, address some of the above long-standing issues. One of the most popular and simplest ways is the use of highly concentrated electrolytes (for example, ≥3.0 M lithium bisfluorosulfonylimide (LiFSI) in ether solvents) to reduce the amount of free (uncoordinated) solvent molecules which are prone to react with lithium metal anode and to improve the anodic stability of electrolytes.^{3,4} However, in concentrated solutions, the anions and solvent molecules compete vigorously for lithium ions (Li⁺) coordination sites, resulting in increased viscosity and reduced mobility of lithium ions. Another popular and simple ways is adding additives to the electrolyte to improve the stability of the electrolyte, and thus reducing the generation of byproducts. However, the additive approach failed to maintain a stable electrode-electrolyte interfaces at practical C rates (e.g., 1 C or above for LMBs).

Therefore, there is an urgent need for a new solution that could mitigate or even eliminate batteries expansion to improve the safety of the battery without degrading the ionic conductivity and rate capability of the cells.

### SUMMARY

In view of this, the present disclosure presents a novel composite metal-organic framework (MOF) material for effectively addressing the major issues as mentioned above.

Particularly, according to a first aspect of the present disclosure, provided is a hybrid membrane used for an electrochemical device, comprising:
a membranous layer, comprising:
   a modified metal-organic framework (MOF) material, wherein the modified MOF material is a MOF material modified with one or more of lithium salts, carboxylic acids, or amino acids, and
   a binder material, for adhering the modified MOF material onto a porous support layer to form the membranous layer thereon, and
a porous support layer, for providing mechanical support for the membranous layer.

In an embodiment, the mass ratio of the modified MOF material to the binder material is 8.5-9.5:0.5-1.5, preferably, 9:1.

In an embodiment, the thickness of the membranous layer is 3-5 μm, preferably, 4 μm.

In an embodiment, organic ligands in the MOF material include one or more of terephthalic acid, trimesic acid, and their derivatives, and metal clusters in the MOF material comprise zirconium or aluminium.

In an embodiment, the MOF material includes UiO-66, UiO-67, HKUST-1, MIL-53, MIL-68, MIL-100, MIL-101, MOF-802, MOF-808, MOF-841, DUT-67, or their combinations.

In an embodiment, the lithium salts include one or more of lithium nitrate (LiNO₃), lithium sulfate (Li₂SO₄), lithium phosphate (Li₃PO₄), lithium carbonate (Li₂CO₃), and lithium acetate (CH₃COOLi), the carboxylic acids include one or more of formic acid, acetic acid, trifluoroacetic acid, trichloroacetic acid, and other fluorinated or chlorinated carboxylic acids, and the amino acids include one or more of glycine, alanine, valine, isoleucine, sarcosine, serine, threonine, histidine, lysine, cysteine, and proline.

In an embodiment, the modified MOF material has chemical formulae of [Al₃O(COO)₆OH], [Zr₆O₄(OH)₄(COO)₁₂], [Zr₆O₄(OH)₄(COO)₆(L)₆], or [Zr₆O₅(OH)₃(COO)₆(RCOO)₅], wherein COO— is the carboxylate groups of the organic ligands, and the L is selected from lithium sulfate ion [(LiSO₄)⁻], formate ion (HCOO⁻), acetate ion (CH₃COO⁻), or their derivatives, and R is selected from —H, —CH₃, —CH₂F, —CHF₂, —CF₃, —CH₂Cl, —CHCl₂, —CCl₃, —CH₂NH₂, —CH₂N(CH₃)₂,

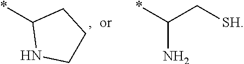 [SMILES: *C1CCCN1 ; ",  or" ; *C(N)CS]

In an embodiment, the binder material includes one or more of polyvinylidene fluoride (PVDF), polytetrafluoroethylene (PTFE), poly(methyl methacrylate) (PMMA), polyacrylonitrile (PAN), polydopamine (PDA), polypyrrole (PPy), polybenzimidazole (PBI), polyvinylimidazole (PVI), polyvinylpyrrolidone (PVP), and their derivatives.

In an embodiment, the porous support layer includes polyolefin-based polymers, such as poly(ethene), poly(propene), or condensation polymers, such as polyamides, polyimides, polyesters.

According to a second aspect of the present disclosure, provided is a method of preparing the hybrid membrane according to the first aspect of the present disclosure, comprising: 1) treating a MOF material with an acid, and adding the resulting MOF material to an aqueous solution of lithium salts, carboxylic acids, or amino acids to obtain modified MOF material, preferably, the concentration of the aqueous solution of the lithium salt, the carboxylic acids, or the amino acids is are 5.0-6.0 M, 1.0-2.0 M, 0.05-0.10 M, respectively; 2) dispersing the modified MOF material in a first solvent to obtain a first solution, dispersing a binder material in a second solvent to obtain a second solution, and mixing the same to obtain a third solution, preferably, the first solvent and the second solvent is N,N-dimethylformamide (DMF), preferably, in the third solution, the mass ratio of the modified MOF materials to the binder materials is 8.5-9.5:0.5-1.5, preferably, 9:1; and 3) coating the third solution onto a porous support layer to obtain hybrid membrane.

According to a third aspect of the present disclosure, provided is an electrochemical device, comprising: a positive electrode, a negative electrode, a non-aqueous electrolyte disposed between the positive electrode and the negative electrode, and a separator disposed in the non-aqueous electrolyte and sandwiched between the positive electrode and the negative electrode, wherein the separator is the hybrid membrane according to the first aspect of the present disclosure.

In an embodiment, the positive electrode includes one or more of lithium cobalt oxides (LCO), lithium manganese oxides (LMO), lithium iron phosphates (LFP), lithium nickel manganese cobalt oxides (NMC or NCM), lithium manganese iron phosphates (LMFP) or lithium manganese nickel oxides (LNMO or LMNO).

In an embodiment, the negative electrode includes one or more of lithium metal electrodes, lithium alloy electrodes, silicon carbon composite electrodes or graphite electrodes.

In an embodiment, the non-aqueous electrolyte includes one or more of lithium salts such as lithium hexafluorophosphate (LiPF₆), lithium nitrate (LiNO₃), lithium tetrafluoroborate (LiBF₄), lithium bisfluorosulfonylimide (LiFSI), lithium bis(trifluoromethanesulfonyl)imide (LiTFSI), lithium bis(oxalate) borate (LiBOB), lithium difluoro(oxalato) borate (LiDFOB), lithium difluorophosphate (LiDFP) in a carbonate-based solvent or a ether-based solvent, the carbonate-based solvent includes ethylene carbonate (EC), propylene carbonate (PC), dimethyl carbonate (DMC), diethyl carbonate (DEC), ethyl methyl carbonate (EMC), fluoroethylene carbonate (FEC), vinylene carbonate (VC), or a combination thereof, and the ether-based solvent includes dimethoxyethane (DME), diethoxyethane (DEE), 1,2-dimethoxypropane (1,2-DMP), 1,3-dimethoxypropane (1,3-DMP), dipropyl ether, dibutyl ether, dipentyl ether, dihexyl ether or a combination thereof.

In an embodiment, the electrochemical device includes lithium based battery, such as lithium ion battery and lithium metal battery.

According to a fourth aspect of the present disclosure, provided is use of the hybrid membrane according to the first aspect of the present disclosure for suppressing Lewis acidic byproducts in an electrochemical device.

In an embodiment, the Lewis acidic byproducts include one or more of HF, CO₂, PF₅ and/or H₂.

In an embodiment, the electrochemical device includes lithium based battery, such as lithium ion battery and lithium metal battery.

In the present disclosure, the inventor designed novel composite MOF materials, and integrated them with conventional or novel binder materials to form a multi-functional hybrid membrane layer. The multi-functional hybrid membrane layer is combined with a porous support layer to form a multi-functional hybrid membrane, which can be used as a separator in an electrochemical device. The multi-functional hybrid membrane layer and the multi-functional hybrid membrane comprising the same feature multiple advantages:
1) dense ion-conducting channels to homogenize and facilitate lithium ion flux, and thus mitigate the dendrite growth;
2) well-defined porous coating with high specific surface area to confine electrolyte molecules and lithium salts, and thus stabilize or deactivate the free solvent molecules and thus alleviate the electrolyte degradation;
3) exposed open metal sites to immobilize anions, and thus enhance the cationic Li⁺ transference number;
4) lithiophilic oxygen donors to increase the overall ion conductivity of composite membranes;
5) low thermal shrinkage (<2% at 200° C. within 2 hours) to reduce the thermal runaway of the battery, and thus improve the safety of the battery;
6) stable electrode-electrolyte interfaces at practical C rates (e.g., 1 C or above for LMBs); and
7) excellent Lewis acidic byproducts suppressing ability offered by the accessible Lewis basic environment created by the integration of at least one type of lithium salts, carboxylic acids, or amino acids and at least one MOF host to capture or scavenge Lewis acidic byproducts such as HF, CO₂, PF₅ and/or H₂ to reduce or even avoid battery expansion, prolong battery life and ensure safety.

### BRIEF DESCRIPTION OF THE DRAWINGS

In order to illustrate the embodiments of the present disclosure or the technical solutions in the prior art more clearly, the following will briefly describe the drawings used in the embodiments. Obviously, the drawings described below only refer to some embodiments of the present disclosure, and the ordinary skilled in the art can obtain other embodiments of the present disclosure based on these drawings, without creative work.

FIG. 1 is a diagram showing the functionalization of a MOF with lithium sulfate according to an embodiment of the present disclosure.

FIG. 2 is a diagram showing the functionalization of a MOF with carboxylic acids or amino acids according to an embodiment of the present disclosure.

FIG. 3 is a diagram showing the structure of a gas scavenged battery inserted with a low-shrinkage and CO₂ scavenging hybrid membrane according to an embodiment of the present disclosure.

FIG. 4 shows galvanostatic cycling test of cells with PE separators coated with lithium salt modified MOF according to an embodiment of the present disclosure and with control PE separators.

FIG. 5 shows galvanostatic cycling test of cells with PE separators coated with glycine modified MOF according to an embodiment of the present disclosure and with control PE separators coated with pristine MOF.

FIG. 6 shows carbon dioxide sorption isotherms of glycine modified MOF and pristine MOF.

### DETAILED DESCRIPTION OF THE INVENTION

The present disclosure will be clearly and completely described below by reference to the embodiments of the present disclosure and the accompanying drawings. Obviously, the described embodiments are only some of the embodiments of the present disclosure, and not all of them. Based on the embodiments of the present disclosure, all other embodiments available to the ordinary skilled in the art fall into the scope of the present disclosure. Also, it is to be understood that the phraseology and terminology employed herein is for the purpose of description and should not be regarded as limiting.

As utilized in accordance with the disclosure, the following terms, unless otherwise indicated, shall be understood to have the following meanings.

Unless otherwise defined herein, technical terms used in connection with the disclosed and/or claimed inventive concept(s) shall have the meanings that are commonly understood by those of ordinary skill in the art. Further, unless otherwise required by context, singular terms shall include pluralities and plural terms shall include the singular.

The singular forms “a”, “an” and “the” include plural forms unless the context clearly dictates otherwise specified or clearly implied to the contrary by the context in which the reference is made. The terms “comprising” and “comprised of” include the more restrictive meanings “consisting essentially of” and “consisting of”.

The term “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “at least one” means one as well as any quantity more than one, including but not limited to, 1, 2, 3, 4, 5, 10, 15, 20, 30, 40, 50, 100, etc. The term “at least one” may extend up to 100 or 1000 or more depending on the term to which it is attached. In addition, the quantities of 100/1000 are not to be considered limiting as lower or higher limits may also produce satisfactory results.

The term “lithium salt” as used in the present disclosure refers to salts containing the element lithium. Non-limiting examples of lithium salt includes lithium nitrate (LiNO₃), lithium sulfate (Li₂SO₄), lithium phosphate (Li₃PO₄), lithium carbonate (Li₂CO₃), lithium acetate (CH₃COOLi).

The term “carboxylic acid” as used in the present disclosure refers to a class of organic compounds containing carboxyl groups (—COOH). Non-limiting examples of carboxylic acids include aliphatic carboxylic acids, alicyclic carboxylic acids, aromatic carboxylic acids.

The term “amino acid” as used in the present disclosure refers to organic compounds that contain a basic amino group and an acidic carboxyl group. Non-limiting examples of amino acids include glycine, alanine, valine, isoleucine, sarcosine, serine, threonine, histidine, lysine, cysteine, proline.

For purposes of the following detailed description, other than in any operating examples, or where otherwise indicated, numbers that express, for example, quantities of ingredients used in the specification and claims are to be understood as being modified in all instances by the term “about”. The numerical parameters set forth in the specification and attached claims are approximations that may vary depending upon the desired properties to be obtained in carrying out the invention.

All publications, articles, papers, patents, patent publications, and other references cited herein are hereby incorporated herein in their entirety for all purposes to the extent consistent with the disclosure herein.

As mentioned above, one challenge met by lithium-based batteries is batteries expansion caused by the generation of byproducts such as CO₂ and H₂. However, the solutions in the prior art will cause the lower ionic conductivity and poor rate capability of the batteries. In this regard, the present disclosure provides a new solution to mitigate or even eliminate batteries expansion without degrading the ionic conductivity and rate capability of the batteries.

In particular, according to a first aspect of the present disclosure, the present disclosure provides a hybrid membrane used for an electrochemical device, comprising: a membranous layer, comprising: a modified metal-organic framework (MOF) material, wherein the modified MOF material is a MOF material modified with one or more of lithium salts, carboxylic acids, or amino acids, and a binder material, for adhering the modified MOF material onto a porous support layer to form the membranous layer thereon, and a porous support layer, for providing mechanical support for the membranous layer.

In an embodiment, the mass ratio of the modified MOF materials to the binder materials is 8.5-9.5:0.5-1.5, such as 8.5:0.5, 9:0.5, 9.5:0.5, 8.5:1, 9:1, 9.5:1, 8.5:1.5, 9:1.5, 9.5:1.5, and preferably, 9:1.

In an embodiment, the thickness of the membranous layer is 3-5 μm, such as 3 μm, 3.5 μm, 4 μm, 4.5 μm, 5 μm, preferably, 4 μm.

Metal-organic frameworks (MOFs) are a class of crystalline micro/mesoporous hybrid materials composed of metal ions or metal clusters interconnected by organic linkers. The MOFs are characterized by an ultra-high specific surface area (>1000 m²/g), highly ordered and accessible pores, which can effectively encapsulate electrolyte components (i.e., lithium salts and solvent molecules), reduce the population of free solvent molecules, and thus scavenge the side reactions with Li metal. Moreover, MOFs have an open framework including exposed open metal sites, and the exposed open metal sites can immobilize anions, and thus enhance the cationic (Li⁺) transference number. On the other hand, the uniform particle size of MOFs in nano scales enables the excellent dispersibility (without sedimentation) in polymeric binder solutions for making composite membranes. Therefore, the inventors applied MOFs to lithium-based batteries to offer solutions to the LMB failure.

In an embodiment, the organic ligands in the MOF materials include one or more of terephthalic acid, trimesic acid, and their derivatives.

In an embodiment, the metal clusters in the MOF material comprise zirconium or aluminium.

In an embodiment, the MOF material includes UiO-66, UiO-67, HKUST-1, MIL-53, MIL-68, MIL-100, MIL-101, MOF-802, MOF-808, MOF-841, DUT-67, or their combinations.

In the present disclosure, the MOF material is functionalized with one or more of lithium salts, carboxylic acids, or amino acids to enhance its electrolyte wettability and lithiophilicity. Functionalization of the MOF material with lithium salts, carboxylic acids, or amino acids is to anchor functions of the same over the pores of the framework for promoting Li-ion conduction, capturing Lewis acidic byproducts such as gas impurities, and immobilizing anions. In addition, the highly porous MOF host anchored with lithium salts or functional molecules can facilitate the diffusion of electrolyte components across the separator for fast kinetics of lithium ion transportation. Furthermore, the high thermal stability and mechanical modulus of MOF materials can effectively mitigate the thermal shrinkage of the hybrid membrane separators.

In an embodiment, the lithium salts include one or more of lithium nitrate (LiNO₃), lithium sulfate (Li₂SO₄), lithium phosphate (Li₃PO₄), lithium carbonate (Li₂CO₃), and lithium acetate (CH₃COOLi).

In an embodiment, the carboxylic acids include one or more of formic acid, acetic acid, trifluoroacetic acid, trichloroacetic acid, and other fluorinated or chlorinated carboxylic acids.

In an embodiment, the amino acids include one or more of glycine, alanine, valine, isoleucine, sarcosine, serine, threonine, histidine, lysine, cysteine, and proline.

In an embodiment, the modified MOF material has chemical formulae of [Al₃O(COO)₆OH], [Zr₆O₄(OH)₄(COO)₁₂], [Zr₆O₄(OH)₄(COO)₆(L)₆], or [Zr₆O₅(OH)₃(COO)₆(RCOO)₅], wherein COO— is the carboxylate groups of the organic ligands, L is selected from lithium sulfate ion [(LiSO₄)⁻], formate ion (HCOO⁻), acetate ion (CH₃COO⁻), or their derivatives, and R is selected from —H, —CH₃, —CH₂F, —CHF₂, —CF₃, —CH₂Cl, —CHCl₂, —CCl₃, —CH₂NH₂, —CH₂N(CH₃)₂,

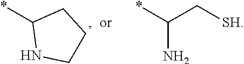 [SMILES: *C1CCCN1 ; ",  or" ; *C(N)CS]

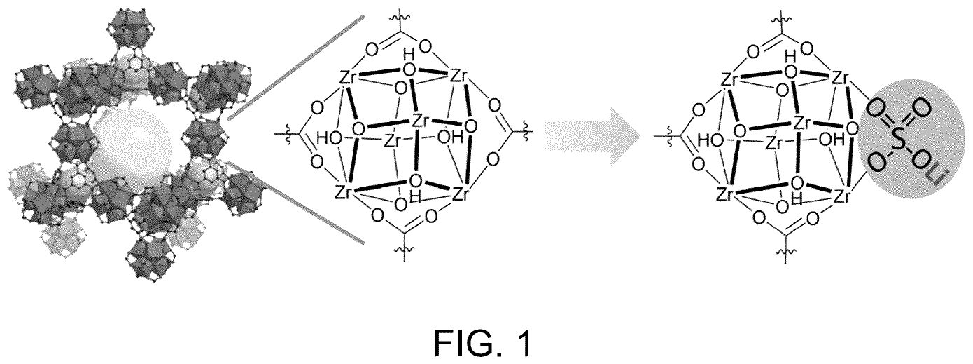

FIG. 1 shows a diagram illustrating the functionalization of a MOF material with lithium sulfate according to an embodiment of the present disclosure, wherein the organic ligands is benzene-1,3,5-tricarboxylic acid and the metal cluster is made by zirconyl chloride or zirconium chloride.

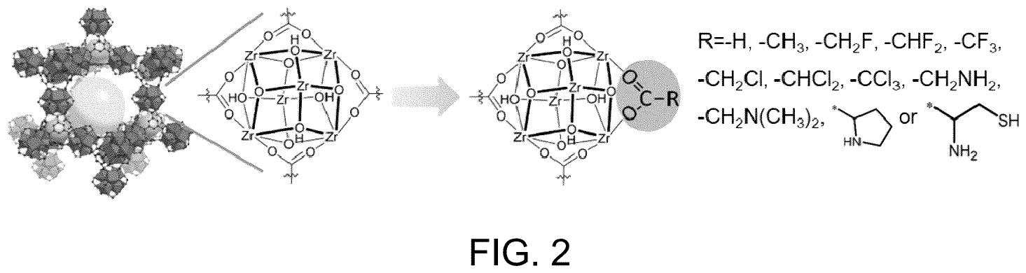

FIG. 2 shows a diagram illustrating the functionalization of a MOF material with carboxylic acids or amino acids according to an embodiment of the present disclosure, wherein the organic ligand is benzene-1,3,5-tricarboxylic acid, the metal cluster is zirconium oxo cluster featuring a chemical formula of [Zr₆O₄(OH)₄]¹²⁺, and the carboxylic acids or amino acids have a structure represented by a chemical formula of RCOOH, wherein the R is —H, —CH₃, —CH₂F, —CHF₂, —CF₃, —CH₂Cl, —CHCl₂, —CCl₃, —CH₂NH₂, —CH₂N(CH₃)₂,

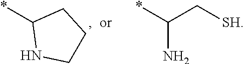 [SMILES: *C1CCCN1 ; ",  or" ; *C(N)CS]

In an embodiment, the modified MOF material is modified MOF nanoparticles (NPs) material.

In the present disclosure, the membranous layer also comprises binder materials, which are used to adhere the modified MOF materials onto a porous support layer to form the membranous layer thereon.

In an embodiment, the binder materials includes one or more of polyvinylidene fluoride (PVDF), polytetrafluoroethylene (PTFE), poly(methyl methacrylate) (PMMA), polyacrylonitrile (PAN), polydopamine (PDA), polypyrrole (PPy), polybenzimidazole (PBI), polyvinylimidazole (PVI), polyvinylpyrrolidone (PVP), and their derivatives.

The hybrid membrane also comprises at least one porous support layer, which is used to provide mechanical support for the membranous layer. In an embodiment, the porous support layer is made of polyolefin-based polymers, such as poly(ethene), poly(propene), or condensation polymers, such as polyamides, polyimides, polyesters. In a further embodiment, the porous support layer is commercial separators, such as poly(ethene), poly(propene), polyamides, polyimides, or polyesters separators.

In the present disclosure, the modified MOF material is mixed with the binder material, and then it was coated onto the porous support layer to remarkably enhance the resistance to thermal shrinkage, improve electrolyte wettability, enhance ionic conductivity, and scavenge Lewis acidic impurities. Specifically, the chosen binder material can achieve a good and intimate contact between the modified MOF material and the porous support layer. The excellent thermal stability of the modified MOF material enables the substantial improvement on the thermal stability of the hybrid membrane. The evenly distributed modified MOF material over the porous support layer can speed up the electrolyte wetting and have a maximum contact surface area with electrodes and electrolyte for suppressing Lewis acidic byproducts such as gas capture.

According to a second aspect of the present disclosure, the present disclosure provides a method of preparing the hybrid membrane according to the first aspect of the present disclosure, comprising: 1) treating a MOF material with an acid, and adding the resulting MOF material to an aqueous solution of lithium salts, carboxylic acids, and/or amino acids to obtain a modified MOF material, 2) dispersing the modified MOF material in a first solvent to obtain a first solution, dispersing a binder material in a second solvent to obtain a second solution, and mixing the same to obtain a third solution, and 3) coating the third solution onto a porous support layer to obtain hybrid membrane.

In an embodiment, in step 1), the concentration of the aqueous solution of the lithium salt is 5.0-6.0 M, such as 5.0 M, 5.1 M, 5,2 M, 5.3 M, 5.4 M, 5.5 M, 5.6 M, 5.7 M, 5.8 M, 5.9 M, 6.0 M, for lithium salts encapsulation into MOF hosts.

In an embodiment, in step 1), the concentration of the aqueous solution of the carboxylic acids is 1.0-2.0 M, such as 1.0 M, 1.1 M, 1.2 M, 1.3 M, 1.4 M, 1.5 M, 1.6 M, 1.7 M, 1.8 M, 1.9 M, 2.0 M, for carboxylic acid encapsulation into MOF hosts.

In an embodiment, in step 1), the concentration of the aqueous solution of the amino acids is 0.05-0.10 M, such as 0.05 M, 0.06 M, 0.07 M, 0.08 M, 0.09 M, 0.10 M, for amino acid encapsulation into MOF hosts.

In an embodiment, in step 2), the first solvent is any solvent that can disperse the modified MOF material such as N,N-dimethylformamide (DMF), N,N-dimethylacetamide (DMA), N-methyl-2-pyrrolidone (NMP), dimethylsulfoxide (DMSO), the second solvent is any solvent that can dissolve the binder material such as N,N-dimethylformamide (DMF), N,N-dimethylacetamide (DMA), N-methyl-2-pyrrolidone (NMP), dimethylsulfoxide (DMSO). Preferably, the first solvent and second solvent are DMF.

In an embodiment, in step 2), the mass ratio of the modified MOF material to the binder material in the third solution is 8.5-9.5:0.5-1.5, such as 8.5:0.5, 9:0.5, 9.5:0.5, 8.5:1, 9:1, 9.5:1, 8.5:1.5, 9:1.5, 9.5:1.5, preferably, 9:1.

In an embodiment, the method comprises the following steps: pristine MOF nanoparticles (5.0 grams) were shaken in aqueous hydrochloric acid (1.0 M, 100 mL) at 80° C. for 24 hours. After cooling to room temperature, the MOF nanoparticles were collected by centrifugation and then washed by distilled water (100 mL×3). The above acid treatment was repeated twice. Afterwards, the treated MOF nanoparticles were shaken in an amino acid solution (0.05-0.10 M amino acids in 800 mL distilled water) at room temperature for 24 hours, followed by centrifugation and washed by distilled water (100 mL×3). This amino acid treatment was repeated twice. Then the modified MOF nanoparticles were dispersed in at least one solvent at total mass loading of the modified MOF between 18 and 20 percent by weight in dispersing solution (denoted as solution A). At least one binder material dissolved in at least one solvent at total mass loading of binder between 6 and 8 percent by weight in dispersing solution (denoted as solution B), followed by the mixing of solution A and solution B using a magnetic stir bar at a temperature range between 23° C. and 50° C. for at least 12 hours. In an embodiment, the at least one solvent is N,N-dimethylformamide (DMF). The mass ratio of modified MOF to binder is 9:1. The resulting precursor solution was coated onto at least one porous support layer using a wire rod or a micro gravure-type roll-to-roll coating machine to afford the hybrid membranes.

According to a third aspect of the present disclosure, the present disclosure provides an electrochemical device, comprising: a positive electrode, a negative electrode, a non-aqueous electrolyte disposed between the positive and negative electrodes, and a separator disposed in the non-aqueous electrolyte and sandwiched between the positive electrode and the negative electrode, wherein the separator is the hybrid membrane according to the first aspect of the present disclosure.

In an embodiment, the positive electrode includes one or more of lithium cobalt oxides (LCO), lithium manganese oxides (LMO), lithium iron phosphates (LFP), lithium nickel manganese cobalt oxides (NMC or NCM), lithium manganese iron phosphates (LMFP) or lithium manganese nickel oxides (LNMO or LMNO).

In an embodiment, the negative electrode includes one or more of lithium metal electrode, lithium alloy electrode, silicon carbon composite electrodes, or graphite electrodes.

In an embodiment, the non-aqueous electrolyte includes one or more of lithium salts such as lithium hexafluorophosphate (LiPF₆), lithium nitrate (LiNO₃), lithium tetrafluoroborate (LiBF₄), lithium bisfluorosulfonylimide (LiFSI), lithium bis(trifluoromethanesulfonyl)imide (LiTFSI), lithium bis(oxalate) borate (LiBOB), lithium difluoro(oxalato) borate (LiDFOB), lithium difluorophosphate (LiDFP) in carbonate-based solvents or ether-based solvents.

In an embodiment, the carbonate-based solvents include ethylene carbonate (EC), propylene carbonate (PC), dimethyl carbonate (DMC), diethyl carbonate (DEC), ethyl methyl carbonate (EMC), fluoroethylene carbonate (FEC), vinylene carbonate (VC), or a combination thereof.

In an embodiment, the ether-based solvents include dimethoxyethane (DME), diethoxyethane (DEE), 1,2-dimethoxypropane (1,2-DMP), 1,3-dimethoxypropane (1,3-DMP), dipropyl ether, dibutyl ether, dipentyl ether, dihexyl ether or a combination thereof.

In an embodiment, the electrochemical device is lithium based battery, such as lithium ion battery and lithium metal battery.

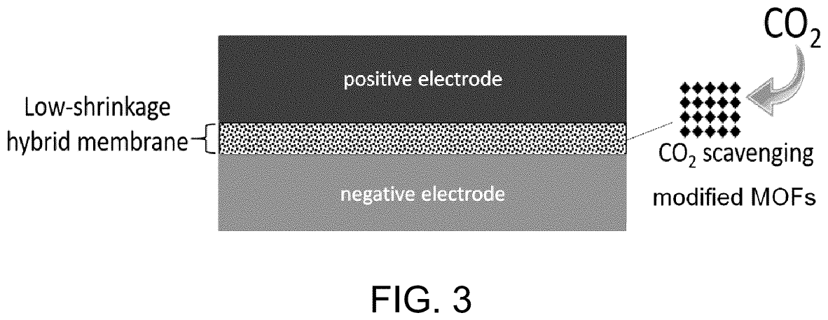

FIG. 3 is a diagram showing the structure of a gas scavenged battery inserted with a low-shrinkage and CO₂ scavenging hybrid membrane, the structure comprises a positive electrode, a negative electrode, and the hybrid membrane according to the first aspect of the present disclosure sandwiched between the positive electrode and the negative electrode.

According to a fourth aspect of the present disclosure, provided is use of the hybrid membrane according to the first aspect of the present disclosure for Lewis acidic byproducts in an electrochemical device.

In an embodiment, the Lewis acidic byproducts are CO₂, H₂, HF, and/or PF₅.

In an embodiment, the electrochemical device includes lithium based battery, such as lithium ion battery and lithium metal battery.

### EXAMPLES

Within this specification, examples have been described in a way which enables a clear and concise specification to be written, but it is intended and will be appreciated that examples may be variously combined or separated without parting from the disclosure. For example, it will be appreciated that all preferred features described herein are applicable to all aspects of the disclosure described herein.

### Example 1

### Preparation of Hybrid Membrane Separator With Lithium Salt Modified MOF

A sample of pristine MOF-808 powder (5.0 g) was dispersed in 0.1 M H₂SO₄ (aq, 500 mL) under magnetic stirring at room temperature for 24 hours. Afterwards, the treated MOF was collected by centrifugation, washed by distilled water until the pH of supernatant of the aqueous phase became neutral. The resulting solution was dried at 150° C. under vacuum for 24 hours to obtain a treated MOF powder. Next, the sulfuric acid treated MOF powder (2.5 g) was dispersed in an aqueous solution of dissolving a lithium salt (50 g) in distilled water (100 mL) under magnetic stirring at room temperature for 24 hours. The reaction product was collected by centrifugation, washed by distilled water (100 mL×5). The product was dried at 100° C. under vacuum for 24 hours to obtain a modified MOF powder.

The modified MOF powder was dispersed in DMF to obtain a first solution, a binder was dispersed in DMF obtain a second solution, and the first solution and the second solution was mixed to obtain a third solution, wherein the mass ratio of the modified MOF material to the binder is 9:1. Coating a PE separator (purchased from MTI corporation) of about 8 μm in thickness, as a porous support layer, with the third solution, obtains a membranous layer of about 4 μm in thickness on the PE separator, namely, hybrid membrane separator with lithium salt modified MOF.

### Performance Test

Conventional electrochemical impedance spectroscopy (EIS) and potentiostatic polarization methods were used to evaluate Li⁺ transference number of electrolytes in PE separators and hybrid membrane separators prepared above. In the example, the electrolyte was 3.0 M LiFSI in 1,2-dimethoxyethane. The results are shown in Table 1. For entry 1 in Table 1, the PE separator was purchased from MTI Corporation. For entry 2 in Table 1, the PE separator was the same as that in entry 1. For entry 3 in Table 1, the NAMI-MOF@PE separator was prepared by the method as mentioned above, wherein the MOF used is lithium salt modified MOF-808 (coating density of 0.23 mg·cm⁻²), the lithium salt used is LiNO₃ (Li content in the modified MOF solid was determined to be 0.14% by ICP-OES), and the binder used is HSV900 PVDF. For entry 4 and 5 in Table 1, the NAMI-MOF@PE separators were prepared by the same method as that in entry 3.

The results show that the hybrid membrane separator (entry 3-5) exhibit about 2.5 times increase in cationic lithium-ion transference number (t_{Li}⁺) compared to the control PE separator (entry 1 and 2) indicating that the hybrid membrane separator effectively improves lithium ion conduction.

TABLE 1
Summary of t_{Li}⁺ measurement using EIS and potentiostatic polarization methods.

| Entry | Separators | thickness | | ΔV | I₀ (A) | Iₛₛ (A) | Rₒ (Ω) | Rₛₛ (Ω) | t_{Li}⁺ |
|---|---|---|---|---|---|---|---|---|---|
| 1 | PE | 8 | μm | 0.01 | 0.000010 | 0.000006 | 729.20 | 733.90 | 0.28 |
| 2 | PE | 8 | μm | 0.01 | 0.000024 | 0.000010 | 226.70 | 219.40 | 0.24 |
| 3 | NAMI-MOF@PE | 8 + 4 | μm | 0.01 | 0.000100 | 0.000086 | 69.00 | 69.65 | 0.67 |
| 4 | NAMI-MOF@PE | 8 + 4 | μm | 0.01 | 0.000110 | 0.000097 | 60.83 | 61.09 | 0.70 |
| 5 | NAMI-MOF@PE | 8 + 4 | μm | 0.01 | 0.000091 | 0.000076 | 66.78 | 66.45 | 0.66 |

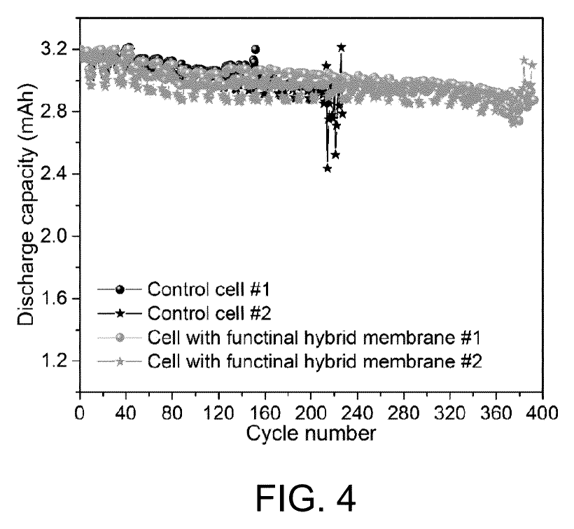

Galvanostatic cycling test were used to evaluate stability of hybrid membrane separator in electrolyte against lithium metal cells using a high-loading LFP cathode (3.2 mAh·cm⁻²), a thin lithium metal anode (Li thickness of 50 μm), and an ether-based electrolyte (3.0 M LiFSI in 1,2-dimethoxyethane) with or without hybrid membrane separator of the present disclosure, and the results are shown in FIG. 4. For control cell #1 in FIG. 4, the separator was purchased from MTI Corporation. For control cell #2 in FIG. 4, the separator was the same as that in control cell #1. For cell with functional hybrid membrance #1 in FIG. 4, the hybrid membrance therein was prepared by the method as mentioned above, wherein the MOF used is lithium salt modifed MOF-808 (coating density of 0.23 mg·cm⁻²), the lithium salt used is LiNO₃ (Li content in the modified MOF solid was determined to be 0.14% by ICP-OES), and the binder used is HSV900 PVDF. For cell with functional hybrid membrance #2 in FIG. 4, the hybrid membrance therein was prepared by the same method as that in cell with functional hybrid membrance #1.

It can be seen from FIG. 4 that the discharge capacity of the lithium metal cells with hybrid membrane separator #1 and #2 showed only a slight decrease (about 14%) after 400 cycles, and discharge capacity of the lithium metal cells without hybrid membrane separator showed great fluctuations and internal shorted after 140 cycles (control cell #1) and 230 cycles (control cell #2), indicating that hybrid membrane separator has remarkably improved cycling stability.

### Example 2

### Preparation of Hybrid Membrane Separator With Glycine Modified MOF

A sample of pristine MOF-808 powder (5.0 g) was dispersed in 1.0 M HCl (aq, 100 mL) under magnetic stirring at 80° C. for three days. Afterwards, the treated MOF was collected by centrifugation, washed by distilled water until the pH of supernatant of the aqueous phase became neutral. The resulting solution was dried at 100° C. under vacuum for 24 hours to obtain a treated MOF powder. Next, the treated MOF powder was dispersed in an aqueous solution of dissolving glycine (3.0 g) and NaOH (1.04 g) in distilled water (800 mL) under magnetic stirring at room temperature for three days. The reaction product was collected by centrifugation, washed by distilled water unto the pH of supernatant of the aqueous phase became neutral. The product was dried at 100° C. under vacuum for 24 hours to obtain a glycine modified MOF powder.

The glycine modified MOF powder was dispersed in DMF to obtain a first solution, a HSV900 PVDF was dispersed in DMF to obtain a second solution, and the first solution and the second solution was mixed to obtain a third solution, wherein the mass ratio of the glycine modified MOF material to the binder is 9:1. Coating a PE separator (purchased from MTI Corporation) of about 8 μm in thickness, as a porous support layer, with the third solution, obtains a membranous layer of about 4 μm in thickness on the PE separator, namely, hybrid membrane separator with glycine modified MOF.

### Preparation of a PE Separator With Pristine MOF

A sample of pristine MOF powder was dispersed in DMF to obtain a first solution, a sample of HSV900 PVDF powder was dispersed in DMF to obtain a second solution, and the first solution and the second solution was mixed to obtain a third solution, wherein the mass ratio of the pristine MOF powder to the binder is 9:1. Coating a PE separator (purchased from MTI Corporation) of about 8 μm in thickness, as a porous support layer, with the third solution, obtains a layer of about 4 μm in thickness, on the PE separator, namely, a PE separator with pristine MOF.

### Performance Test

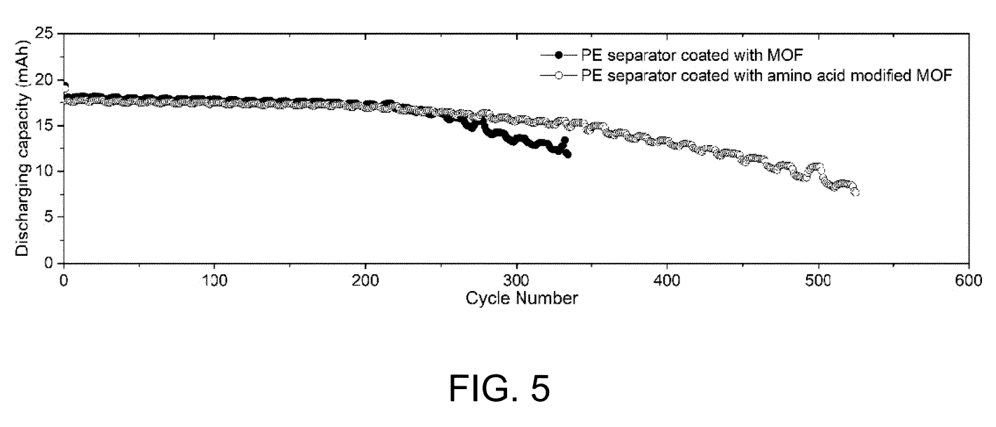

Galvanostatic cycling performance test was used to evaluate stability of hybrid membrane separator in electrolyte against lithium metal cells using a LCO cathode (2.0 mAh·cm⁻², active area of 2×4.5 cm²), a thin lithium metal anode (Li thickness of 50 μm, area of 5×2.5 cm²), and an ether-based electrolyte (3.0 M LiFSI in 1,3-dimethoxypropane, 270 μL) with hybrid membrane separator (with glycine modified MOF) or with PE separator (with pristine MOF) prepared above (area of 5.5×2.8 cm²). The as-fabricated single-layer pouches were rest for 24 hours in order to achieve full wetting of electrodes and separators and then under a formation cycle at 0.05 C charge (0.1 mA·cm⁻²) and 0.2 C discharge (0.4 mA·cm⁻²). Afterwards, the pouches were cycled at 1 C charge and 1 C discharge (2.0 mA·cm⁻²). The cycling results are summarized in FIG. 5. It can be seen from FIG. 5 that the lithium metal cells with hybrid membrane separator with glycine modified MOF prepared above showed extended cycle life at 1 C charge and discharge rate. For example, at the 300^{th} cycle, the cell delivered 15.52 mAh discharge capacity higher than that of the control cell (13.64 mAh) with PE separator with pristine MOF.

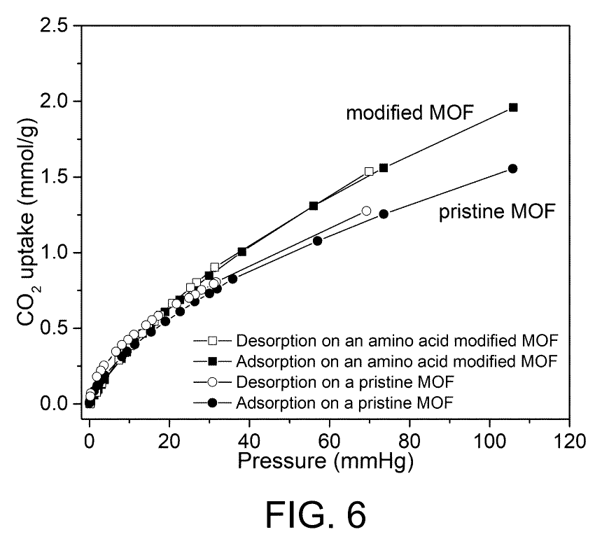

The carbon dioxide scavenging ability of pristine MOF and glycine modified MOF solids prepared above was determined using a gas sorption analyzer, and the results are shown in FIG. 6. The carbon dioxide sorption isotherms (at a temperature of 273 K) of glycine modified MOF exhibited higher carbon dioxide uptake capacity compared to pristine MOF, indicating the enhanced carbon dioxide capturing ability which can reduce the battery expansion due to gas formation during repeated cycles.

### REFERENCES

1. Tarascon, J. M. & Armand, M. Issues and challenges facing rechargeable lithium batteries. Nature 414, 359-367, doi:10.1038/35104644 (2001).
2. Armand, M. & Tarascon, J. M. Building better batteries. Nature 451, 652-657, doi:10.1038/451652a (2008).
3. Seo, D. M., Borodin, O., Han, S.-D., Boyle, P. D. & Henderson, W. A. Electrolyte Solvation and Ionic Association II. Acetonitrile-Lithium Salt Mixtures: Highly Dissociated Salts. Journal of The Electrochemical Society 159, A1489, doi:10.1149/2.035209jes (2012).
4. Wang, M. et al. Effect of LiFSI Concentrations To Form Thickness- and Modulus-Controlled SEI Layers on Lithium Metal Anodes. The Journal of Physical Chemistry C 122, 9825-9834, doi:10.1021/acs.jpcc.8b02314 (2018).

What is claimed is:

1. A hybrid membrane used for an electrochemical device, comprising:
a membranous layer, comprising:
a modified metal-organic framework (MOF) material, wherein the modified MOF material is a MOF material modified with one or more of lithium salts, carboxylic acids, or amino acids, and
a binder material, for adhering the modified MOF material onto a porous support layer to form the membranous layer thereon, and
a porous support layer, for providing mechanical support for the membranous layer.

2. The hybrid membrane according to claim 1, wherein a mass ratio of the modified MOF material to the binder material is 8.5-9.5:0.5-1.5.

3. The hybrid membrane according to claim 1, wherein a thickness of the membranous layer is 3-5 μm.

4. The hybrid membrane according to claim 1, organic ligands in the MOF material include one or more of terephthalic acid, trimesic acid, and their derivatives, and metal clusters in the MOF material comprise zirconium or aluminium.

5. The hybrid membrane according to claim 1, wherein the MOF material includes UiO-66, UiO-67, HKUST-1, MIL-53, MIL-68, MIL-100, MIL-101, MOF-802, MOF-808, MOF-841, DUT-67, or their combinations.

6. The hybrid membrane according to claim 1, wherein the lithium salts include one or more of lithium nitrate, lithium sulfate, lithium phosphate, lithium carbonate, and lithium acetate, the carboxylic acids include one or more of formic acid, acetic acid, trifluoroacetic acid, trichloroacetic acid, and other fluorinated or chlorinated carboxylic acids, and the amino acids include one or more of glycine, alanine, valine, isoleucine, sarcosine, serine, threonine, histidine, lysine, cysteine, and proline.

7. The hybrid membrane according to claim 1, wherein the modified MOF material has chemical formulae of [Al₃O(COO)₆OH], [Zr₆O₄(OH)₄(COO)₁₂], [Zr₆O₄(OH)₄(COO)₆(L)₆], or [Zr₆O₅(OH)₃(COO)₆(RCOO)₅], wherein COO— is carboxylate groups of organic ligands, L is selected from lithium sulfate ion, formate ion, acetate ion, or their derivatives, and R is selected from —H, —CH₃, —CH₂F, —CHF₂, —CF₃, —CH₂Cl, —CHCl₂, —CCl₃, —CH₂NH₂, —CH₂N(CH₃)₂,

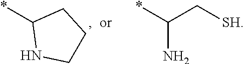 [SMILES: *C1CCCN1 ; ",  or" ; *C(N)CS]

8. The hybrid membrane according to claim 1, wherein the binder material includes one or more of polyvinylidene fluoride, polytetrafluoroethylene, poly(methyl methacrylate), polyacrylonitrile, polydopamine, polypyrrole, polybenzimidazole, polyvinylimidazole, polyvinylpyrrolidone, and their derivatives.

9. The hybrid membrane according to claim 1, wherein the porous support layer includes polyolefin-based polymers and condensation polymers, and the polyolefin-based polymers include poly(ethene), poly(propene), and the condensation polymers include polyamides, polyimides, polyesters.

10. A method for preparing the hybrid membrane of claim 1, comprising:
1) treating the MOF material with an acid, and adding the resulting MOF material to an aqueous solution of the lithium salts, the carboxylic acids, or the amino acids to obtain the modified MOF material;
2) dispersing the modified MOF material in a first solvent to obtain a first solution, dispersing the binder material in a second solvent to obtain a second solution, and mixing the same to obtain a third solution; and
3) coating the third solution onto the porous support layer to obtain the hybrid membrane.

11. The method according to claim 10, wherein in the step 1), a concentration of the aqueous solution of the lithium salts, the carboxylic acids, or the amino acids are 5.0-6.0 M, 1.0-2.0 M, 0.05-0.10 M, respectively.

12. The method according to claim 10, wherein in the step 2), a mass ratio of the modified MOF material to the binder material in the third solution is 8.5-9.5:0.5-1.5.

13. An electrochemical device, comprising:
a positive electrode,
a negative electrode,
a non-aqueous electrolyte disposed between the positive electrode and the negative electrode, and
a separator disposed in the non-aqueous electrolyte and sandwiched between the positive electrode and the negative electrode, wherein the separator is the hybrid membrane of claim 1.

14. The electrochemical device according to claim 13, wherein the positive electrode includes one or more of lithium cobalt oxides, lithium manganese oxides, lithium iron phosphates, lithium nickel manganese cobalt oxides, lithium manganese iron phosphates or lithium manganese nickel oxides, and the negative electrode includes one or more of lithium metal electrode, lithium alloy electrode, or graphite electrode.

15. The electrochemical device according to claim 13, wherein the non-aqueous electrolyte includes one or more of lithium salts in a carbonate-based solvent or a ether-based solvent, the lithium salts include lithium hexafluorophosphate lithium nitrate, lithium tetrafluoroborate, lithium bisfluorosulfonylimide, lithium bis(trifluoromethanesulfonyl)imide, lithium bis(oxalate) borate, lithium difluoro(oxalato) borate, lithium difluorophosphate or a combination thereof, the carbonate-based solvent includes ethylene carbonate, propylene carbonate, dimethyl carbonate, diethyl carbonate, ethyl methyl carbonate, fluoroethylene carbonate, vinylene carbonate, or a combination thereof, and the ether-based solvent includes dimethoxyethane, diethoxyethane, 1,2-dimethoxypropane, 1,3-dimethoxypropane, dipropyl ether, dibutyl ether, dipentyl ether, dihexyl ether or a combination thereof.

16. The electrochemical device according to claim 13, wherein the electrochemical device includes lithium based battery, and the lithium based battery includes lithium ion battery and lithium metal battery.

17. A method of using the hybrid membrane of claim 1 for suppressing Lewis acidic byproducts in an electrochemical device.

18. The method according to claim 17, wherein the Lewis acidic byproducts include CO₂, H₂, HF, and/or PF₅.

19. The method according to claim 17, wherein the electrochemical device includes lithium based battery, and the lithium based battery includes lithium ion battery and lithium metal battery.
